(19) United States
(12) Patent Application Publication
(10) Pub. No.: US 2017/0006564 A1
(43) Pub. Date: Jan. 5, 2017

(54) Configuration method, node and system for implementing air interface synchronization

(71) Applicant: ZTE CORPORATION, Shenzhen, Guangdong (CN)

(72) Inventors: Wei Gou, Shenzhen (CN); Huaming Wu, Shenzhen (CN); Yajun Zhao, Shenzhen (CN); YuNgok Li, Shenzhen (CN); Focai Peng, Shenzhen (CN); Xiaogang Han, Shenzhen (CN)

(21) Appl. No.: 15/113,587

(22) PCT Filed: Dec. 10, 2014
(86) PCT No.: PCT/CN2014/093513

§ 371 Date: Jul. 22, 2016

(30) Foreign Application Priority Data
Jan. 24, 2014 (CN) 201410036888.4

(51) Int. Cl. H04W 56/00; H04W 76/04; H04W 72/04

(52) U.S. Cl. CPC H04W 56/001; H04W 72/0446; H04W 76/046; H04W 92/20

(57) ABSTRACT

Disclosed is a configuration method for implementing air interface synchronization including that: a network side determines the number of layers to which cells are divided in an Operation, Administration and Maintenance (OAM) manner or by a specified node, configures a monitoring subframe position for air interface synchronization to the cells of each determined layer, and sends or configures the number of layers and information of the monitoring subframe position configured for the cells of each layer; or, the network side determines a source cell configurable to be monitored by a local cell for air interface synchronization in the OAM manner, configures cell information corresponding to the source cell and configures the cell information to be the local cell; or, the specified node determines a source cell configurable to be monitored by a local cell for air interface synchronization, configures cell information corresponding to the source cell, and sends the cell information as the local cell. The present disclosure further discloses a configuration node and system for implementing air interface synchronization.

### TECHNICAL FIELD

The present disclosure relates to mobile wireless communications, and in particular to a configuration method, node and system for implementing air interface synchronization.

### BACKGROUND

At present, a synchronization solution for a small cell and a macro cell in a Long Term Evolution (LTE) system is being researched, in particular, an air-interface-based synchronization solution. The basic principle of the synchronization solution is that the small cell receives a Cell Reference Signal (CRS) from the macro cell, calculates a time deviation from the macro cell and thus calibrates its own timing to achieve synchronization with the macro cell.

Currently, the air interface synchronization has been researched on the basis of a Multicast/Broadcast Single Frequency Network (MBSFN)-subframe-based manner. The basic principle of the MBSFN-subframe-based manner is as follows.

A small cell monitors a CRS sent by a macro cell, where the term “monitor” herein means receiving. That is, the small cell receives the CRS sent by the macro cell, thereby implementing synchronization with the macro cell. Meanwhile, the small cell configures its own subframe which received the CRS from the macro cell (i.e. a monitoring subframe) as an MBSFN subframe, and sends the MBSFN subframe to affiliated User Equipment (UE).

However, such a manner may cause serious interference between small cells because the small cells are required to interact about position information of monitoring subframes. In particular, under the condition of higher distribution density of the small cells, interference is exceptionally serious, thereby seriously affecting a monitoring synchronization effect of the small cells. In order to solve the problem of interference, it has been disclosed that an existing Resource Element (RE) or subframe muting may be adopted. However, if each of small cells independently configures the position of its own monitoring subframe, all of the other cells are required to keep muting at position of the monitoring subframe of each of the small cells, which apparently may multiply resources required for muting.

In addition, in consideration of possibility of asynchronization between adjacent macro cells in a Frequency Division Duplex (FDD) system, if an affiliated small cell 1 of a macro cell 1 monitors an adjacent macro cell 2 or a reference signal of an affiliated small cell of the macro cell 2 is configured for air interface synchronization, the small cell 1 apparently may think that it has been kept synchronized with the macro cell 1, but in fact, the small cell 1 has yet not been kept synchronized with the macro cell 1.

### SUMMARY

In order to solve the existing technical problems, the embodiments of the present disclosure provide a configuration method, node and system for implementing air interface synchronization.

The embodiments of the present disclosure provide a configuration method for implementing air interface synchronization, which includes that:

a network side determines the number of layers to which cells are divided in an Operation, Administration and Maintenance (OAM) manner or by a specified node, configures monitoring subframe positions for air interface synchronization for the cells of each determined layer, and sends or configures the number of layers and information of the monitoring subframe positions for the cells of each layer; or,

the network side determines a source cell configurable to be monitored by a local cell for air interface synchronization in the OAM manner, configures cell information corresponding to the source cell and configures the cell information to be the local cell; or,

the specified node determines a source cell configurable to be monitored by a local cell for air interface synchronization, configures cell information corresponding to the source cell, and sends the cell information as the local cell.

The embodiments of the present disclosure further provide a configuration method for implementing air interface synchronization, which includes:

a related cell receives the number of layers, to which cells are divided, configured in an OAM manner and information of monitoring subframe positions configured to the cells of each layer for air interface synchronization; or,

the related cell receives layer numbers to which cells are divided and information of monitoring subframe positions configured to the cells of each layer for air interface synchronization; or,

the related cell receives cell information corresponding to a source cell which is monitored for air interface synchronization; or,

the related cell receives cell information corresponding to a source cell which is monitored for air interface synchronization in the OAM manner.

The embodiments of the present disclosure further provide a configuration node for implementing air interface synchronization, including: a configuration module and a transmission module, wherein

the configuration module may be configured to determine the number of layers to which cells are divided and configure monitoring subframe positions for air interface synchronization for the cells of each determined layer, or may be configured to determine a source cell configurable to be monitored by a local cell for air interface synchronization, configure cell information corresponding to the source cell and configure the cell information to be the local cell; and

the transmission module may be configured to send or configure the number of layers and information of the monitoring subframe positions configured to the cells of each layer, or may be configured to send the cell information as the local cell.

The embodiments of the present disclosure further provide a configuration node for implementing air interface synchronization, including a receiving module, configured to receive the number of layers, to which cells are divided, configured in an OAM manner and information of monitoring subframe positions configured to the cells of each layer for air interface synchronization,

or configured to receive the number of layers to which cells are divided and information of monitoring subframe positions configured to the cells of each layer for air interface synchronization, or

configured to receive cell information corresponding to a source cell which is monitored for air interface synchronization, or

configured to receive cell information corresponding to a source cell which is monitored for air interface synchronization in the OAM manner.

The embodiments of the present disclosure further provide a configuration system for implementing air interface synchronization, including the abovementioned two nodes.

The embodiments of the present disclosure further provide a configuration method for implementing air interface synchronization, which includes that: a local cell receives air interface synchronization reference signals from a plurality of cells, determines a source cell or candidate source cell suitable for the local cell, and notifies the source cell or a specified node of determined source cell information or candidate source cell information.

The embodiments of the present disclosure further provide a configuration method for implementing air interface synchronization, which includes that: a source cell receives source cell information or candidate source cell information notified by a local cell; and

the source cell information or candidate source cell information is a source cell or candidate source cell, determined by air interface synchronization reference signals received from a plurality of cells by the local cell, suitable for the local cell.

The embodiments of the present disclosure further provide a configuration node for implementing air interface synchronization, which includes: a receiving module and a notification module, wherein

the receiving module may be configured to receive air interface synchronization reference signals of a plurality of cells, and determine a source cell or candidate source cell suitable for a local cell; and

the notification module may be configured to notify the source cell or a specified node of source cell information or candidate source cell information determined by the receiving module.

The embodiments of the present disclosure further provide a configuration node for implementing air interface synchronization, which includes: a receiving module, configured to receive source cell information or candidate source cell information notified by a local cell; and

the source cell information or the candidate source cell information may be a source cell or candidate source cell, determined by air interface synchronization reference signals received from a plurality of cells by the local cell, suitable for the local cell.

According to the configuration method, node and system for implementing air interface synchronization provided by the embodiments of the present disclosure, the network side determines the number of layers to which the cells are divided in the OAM manner or by the specified node, determines the monitoring subframe positions for air interface synchronization for the cells of each determined layer, and sends or configures the number of layers and the information of the monitoring subframe positions for the cells of each layer; or, the network side determines the source cell configurable to be monitored by the local cell for air interface synchronization in the OAM manner, configures the cell information corresponding to the source cell and configure the cell information to be the local cell; or, the specified node determines the source cell configurable to be monitored by the local cell for air interface synchronization, configures the cell information corresponding to the source cell and sends the cell information a the cell. As can be seen, in the embodiments of the present disclosure, a unified node is adopted to configure the monitoring subframe positions and the number of layers, which is favourable for implementation of a subframe muting or RE muting solution, greatly reduces resources required by muting and may avoid signalling interaction. Otherwise, small cells are required to interact about information of monitoring subframe positions, thereby causing muting of the other small cells at the monitoring subframe position of the local small cell.

In addition, in the embodiments of the present disclosure, after cell information which may be configured as a source cell is notified to a small cell, a monitoring step and calculation of the small cell are favourably simplified, and the problem of misunderstanding of the small cell about synchronization with a macro cell is solved.

### BRIEF DESCRIPTION OF THE DRAWINGS

In the drawings (which may not be drawn to scale), similar reference signs may describe similar parts in different views. Similar reference signs with different suffix letters may represent different examples of similar parts. The drawings substantially show each of the embodiments discussed in the present disclosure in an exemplary and unlimited manner.

FIG. 1 is a flowchart showing a configuration method for implementing air interface synchronization according to an embodiment of the present disclosure;

FIG. 2 is a structural diagram illustrating a configuration node for implementing air interface synchronization according to an embodiment of the present disclosure;

FIG. 3 is a structural diagram illustrating a configuration node for implementing air interface synchronization according to another embodiment of the present disclosure;

FIG. 4 is a structural diagram illustrating a configuration node for implementing air interface synchronization according to another embodiment of the present disclosure; and

FIG. 5 is a structural diagram illustrating a configuration node for implementing air interface synchronization according to another embodiment of the present disclosure.

### DETAILED DESCRIPTION

Implementation modes of the present disclosure will be described below with reference to embodiments in detail, so as to adequately understand and accordingly implement an implementation process of solving the technical problem by virtue of technical means and achieving technical effects in the present disclosure.

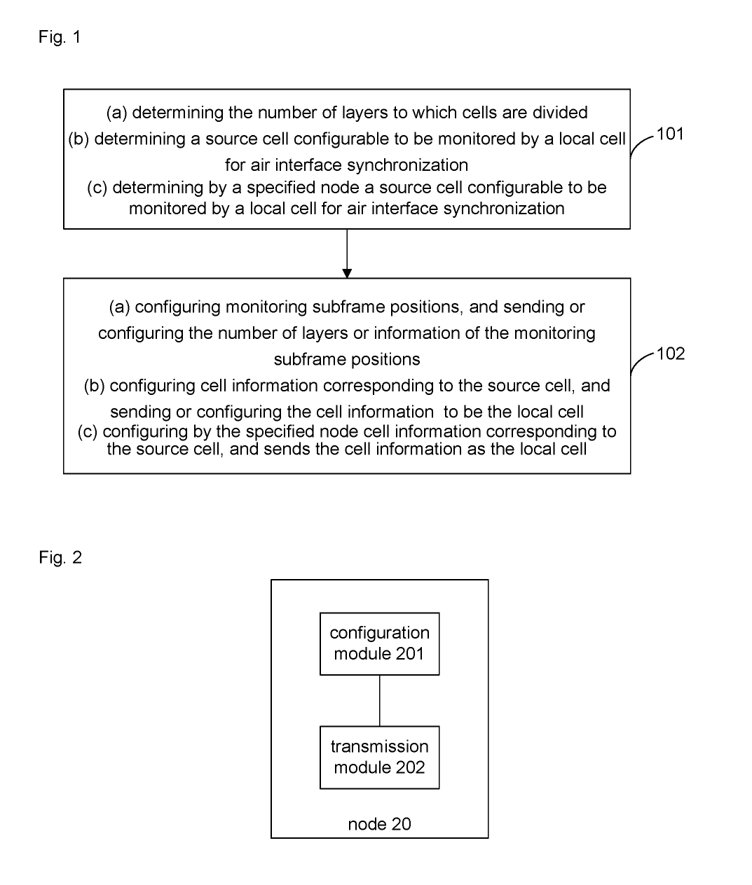

The embodiments of the present disclosure provide a configuration method for implementing air interface synchronization, and as shown in FIG. 1, the method includes:

Step 101(a): a network side determines the number of layers to which cells are divided in an OAM manner, or a specified node determines the number of layers to which the cells are divided; and

Step 102(a): a position of a monitoring subframe for air interface synchronization is configured for each determined layer of the cells, and the number of layers and information of the position of the monitoring subframe configured for each layer of the cells are sent or configured;

or,

Step 101(b): the network side determines a source cell which is capable of being monitored by a local cell for air interface synchronization in the OAM manner; and

Step 102(b): the network side configures cell information corresponding to the source cell, and configures the cell information to be the local cell;

or,

Step 101(c): the specified node determines a source cell which is capable of being monitored by a local cell for air interface synchronization (the local cell is also called a target cell, that is, a candidate source cell which is capable of being monitored by the target cell for air interface synchronization is determined); and

Step 102(c): the specified node configures cell information corresponding to the source cell, and sends the cell information as the local cell.

In an embodiment, the specified node is a macro cell. Alternatively, the specified node may also be a specified small cell.

For example, in some cases, some small cells or a small cell cluster is deployed, but these small cells are not covered by a macro cell. Then, a certain small cell may be selected as a specified node to configure information of candidate source cells of these small cells. Alternatively, a small cell is selected from the small cell cluster as a specified node to configure information of candidate source cells of other small cells in the cluster.

Herein, the source cell refers to: a cell providing air interface synchronization for other cells, which is explained hereinafter in detail.

Herein, the cell information corresponding to the source cell which is capable of being monitored for air interface synchronization includes: frequency point information and cell physical Identifier (ID) of the cell, or includes: the frequency point information, cell physical ID and bandwidth information of the cell; or,

the cell information corresponding to the source cell which is capable of being monitored for air interface synchronization includes: information of a cell cluster where the source cell is located, or, includes: the frequency point information, cell physical ID and timing deviation information of the cell.

Herein, the timing deviation information is specifically timing deviation information between the cell corresponding to the cell physical ID and a macro cell to which the local cell belongs.

Herein, the cell information corresponding to the source cell which is capable of being monitored for air interface synchronization is sent in the following manners: an air interface manner, or by a wired interface, such as an X2 interface or a backhaul link interface. Alternatively, a core network at the network side sends the cell information through an S1 interface. For example, the specified node sends the cell information through the X2 interface; and for example, the specified node sends the cell information to the core network (through the S1 interface), and then the core network sends the cell information to the local cell through the S1 interface.

Herein, the cell information corresponding to the source cell which is capable of being monitored for air interface synchronization is sent after the local cell selects the source cell for the first time, or before the local cell selects the source cell for the first time. For the latter, the local cell establishes a connection with any cell at first during deployment, the local cell performs measurement to discover a part of cells which may serve as candidate source cells after the connection is established, and reports the cells to the specified node. The specified node determines and sends a candidate source cell to the local cell after comprehensive consideration (including factors such as the number of layers and a geographical position).

In an embodiment, when the local cell is a small cell, the configured source cell (which is also a candidate source cell) includes: a small cell belonging to the same macro cell (or called a local macro cell, i.e. a macro cell to which the local cell belongs) with the local cell and the macro cell.

In an embodiment, when the local cell is a small cell, the method further includes that:

when the specified node determines that an adjacent macro cell is kept synchronized with it, the adjacent macro cell and its small cell are determined as candidate source cells or source cells which are monitored by the local cell for air interface synchronization.

In an embodiment, the method further includes that: the specified node selects one or more cells from received information of potential source cells as (a) candidate source cell(s) or source cell(s) of the local cell; or, the specified node specifies a cell as a source cell of the local cell; or, the local cell selects one cell from candidate source cells as a source cell of the local cell.

In an embodiment, for an initially deployed small cell, the small cell may perform measurement to learn about information of adjacent cells (these cells are potential source cells), the small cell may notify the specified node of the information of the adjacent cells, and the specified node selects one or more cells from the received information of the adjacent cells as (a) candidate source cell(s) or source cell(s) of the local cell. A specific selection rule may refer to the above description.

In an embodiment, the method further includes that: the specified node sets monitoring radio frame and/or subframe positions, configured for air interface synchronization, of source cells of the same layer to be the same.

The present disclosure further provides a negotiation manner for determining a candidate source cell or a source cell as follows:

the local cell (target cell) implements interaction with an adjacent cell in an air interface signalling interaction manner, or an X2 interface interaction manner or a manner of interaction with the S1 interface of the core network, and selects the candidate source cell or source cell of the local cell from interaction.

Specifically, the local cell receives air interface synchronization reference signals from multiple adjacent cells, and determines the adjacent cell meeting a requirement as own candidate source cell or source cell according to a set threshold. Optionally, the local cell may send determined candidate source cell information or source cell information to the corresponding source cell. The local cell may send the information to the candidate source information through a dedicated Radio Resource Control (RRC) message, so that the source cell may learn about that it is determined as the candidate source cell or source cell of the local cell.

Alternatively, the local cell receives the air interface synchronization reference signals from the multiple adjacent cells, and judges whether the adjacent cells may serve as the candidate source cell or the source cell or not, thereby determining its own candidate source cell or source cell. The local cell sends the candidate source cell information or source cell information of the local cell to the corresponding source cell through the X2 interface, so that the source cell may learn about that it is determined as the candidate source cell or source cell of the local cell.

Alternatively, the local cell receives the air interface synchronization reference signals from the multiple adjacent cells, judges whether the adjacent cells may serve as the candidate source cell or the source cell or not, thereby determining its own candidate source cell or source cell. The local cell may send the candidate source cell information or source cell information of the local cell to the core network (such as a Mobility Management Entity, MME) through the S1 interface, and then the MME sends the candidate source cell information or the source cell information to the corresponding source cell through the S1 interface, so that the source cell may learn about that it is determined as the candidate source cell or source cell of the local cell.

In such a manner, the source cell is required to take its own specific off state into consideration when switching off. For example, after the source cell turns off, it needs to consider whether the source cell is required to be awakened at a monitoring subframe position of the local cell and send an air interface synchronization reference signal or not. If the local cell may not determine another suitable source cell after the source cell is off, the source cell is still required to be awakened at the monitoring subframe position of the local cell and send the air interface synchronization reference signal at the subframe position after being off.

In the embodiments of the present disclosure, operation for processing the candidate source cell of the local cell may be equivalently applicable for operation over the source cell of the local cell. For example, a manner for transmitting the candidate source cell information is also applicable for transmission of the source cell information. When the local cell determines only one candidate source cell, the source cell of the local cell is equivalently determined.

The embodiments of the present disclosure further provide a configuration method for implementing air interface synchronization, which includes that:

a related cell receives the number of layers, to which cells are divided, configured in an OAM manner and information of monitoring subframe positions configured for the cells of each layer for air interface synchronization; or, the related cell receives the number of layers to which cells are divided and information of monitoring subframe positions configured for the cells of each layer for air interface synchronization; or, the related cell receives cell information corresponding to a source cell which is monitored for air interface synchronization; or, the related cell receives cell information corresponding to a source cell which is monitored for air interface synchronization in the OAM manner.

Herein, the related cell includes: a small cell belonging to the same macro cell and the macro cell.

Herein, the source cell refers to: a cell providing air interface synchronization for other cells, which is explained hereinafter in detail.

In an embodiment, the step that the related cell receives the cell information corresponding to the source cell which is monitored for air interface synchronization includes that:

the related cell receives the cell information through an X2 interface of a backhaul link, or the related cell receives the cell information sent by a core network through an S1 interface.

In an embodiment, after the step that the related cell receives the number of layers to which the cells are divided and the information of the monitoring subframe positions configured for the cells of each layer for air interface synchronization, the method further includes that:

the related cell determines its own number of layers, and determines its own configured monitoring subframe position according to the determined number of layers.

Herein, the step that the related cell determines its own number of layers includes that:

its own source cell is determined by detection, and the number of layers of the source cell is acquired, thereby determining its own number of layers by adding 1 to the number of layers of the source cell.

In an embodiment, when the related cell is a source cell, the method further includes that:

the related cell determines its own configured monitoring subframe position according to its own determined number of layers.

In an embodiment, the method further includes that: the related cell sends a monitored signal in its own configured monitoring subframe.

In an embodiment, the method further includes that:

the related cell keeps subframe muting in another monitoring subframes except its own monitoring subframe; or,

the related cell keeps muting of an RE corresponding to the monitored signal in the other subframes except its own monitoring subframe.

For subframe muting or RE muting, specific implementation should refer to density of small cells. Usually, in a high-density condition, there is serious mutual interference due to many small cells, and thus a muting mechanism should be executed. If the small cells are sparse, interference between the small cells is usually low, so that muting may not be implemented in consideration of resource waste or performance reduction of the muting mechanism. A specific density threshold may be obtained by testing or simulation.

In an embodiment, the method further includes that:

the related cell executes monitoring operation at monitoring subframe positions configured for each layer respectively, and tries to select a suitable source cell.

In an embodiment, after the step that the related cell receives the cell information corresponding to the source cell which is monitored for air interface synchronization, the method further includes that: the related cell detects its own source cell by virtue of the cell information.

In an embodiment, the method further includes that: the related cell reports selected source cell information, the source cell information including: a cell physical ID.

In an embodiment, the method further includes that: the related cell reports information of a detected candidate source cell.

In an embodiment, the method further includes that: the related cell selects the source cell according to a principle as follows: a small cell in the same cluster is preferably selected from multiple source cells consistent with a source cell measurement threshold as the source cell.

The embodiments of the present disclosure further provide a configuration method for implementing air interface synchronization, which includes that:

a local cell receives air interface synchronization reference signals from multiple cells, determines a source cell or candidate source cell suitable for the local cell, and notifies the source cell or a specified node of determined source cell information or candidate source cell information.

In an embodiment, a method for notifying the source cell or the specified node of the determined source cell information or candidate source cell information includes that:

the local cell notifies the source cell or the specified node through a dedicated RRC message; or,

the local cell notifies the source cell or the specified node through an X2 interface; or,

the local cell notifies a core network through an S1 interface, and then the core network notifies the source cell or the specified node through an S1 interface.

The embodiments of the present disclosure further provide a configuration method for implementing air interface synchronization, which includes that:

a source cell receives source cell information or candidate source cell information notified by a local cell; and

the source cell information or the candidate source cell information is a source cell or candidate source cell, determined by air interface synchronization reference signals received from multiple cells by the local cell, suitable for the local cell.

In an embodiment, after the step that the source cell receives the source cell information or candidate source cell information notified by the local cell, the method further includes that:

the source cell learns about that it serves as a source cell or candidate source cell of another cell except itself, and after switching off, the source cell is awakened at a subframe position where an air interface synchronization reference signal from the source cell is received by the local cell and sends the air interface synchronization reference signal at the subframe position.

The method of the present disclosure will be further described below with reference to the drawings and specific embodiments in detail.

In the embodiments of the present disclosure, when a monitoring manner is adopted for synchronization between small cells and macro cells and between the small cells, a network side should configure monitoring subframe positions for the macro cells and the affiliated small cells of the macro cells in a unified manner through a specified node and establish a corresponding relationship between the number of layers and a subframe position. For example, the monitoring subframe positions of each layer are kept the same, so that the macro cells and the small cells may all determine the number of layers when the cell (or the small cell) serves as a source cell through the monitoring subframe positions, which is equivalent to that the number of layers is implicitly notified through the predetermined monitoring subframe positions.

A monitoring-based air interface synchronization manner and the source cell are defined as follows. Cell 1 receives a reference signal sent by cell 2, thereby estimating a timing deviation between cell 1 and cell 2 and regulating timing of cell 1 to be kept consistent with that of cell 2 (that is, cell 1 is kept synchronized with cell 2). Herein, cell 2 is called a source cell of cell 1, and there is no strict requirement on whether cell 2 learns about that cell 1 is kept synchronized with it in a monitoring manner or not. Cell 1 is the local cell in Step 101(a) and Step 101(b), also called a target cell.

In addition, a background OAM manner of an operator may also be adopted to correspondingly configure the monitoring subframe positions of each layer and notify information to the macro cells and the affiliated small cells of the macro cells, so that the macro cells and the small cells may learn about which subframes of each layer are required to be configured for monitoring the other cells. In such a manner, the macro cells or the small cells keep monitored reference signals sent in their own corresponding monitoring subframes after learning about their own numbers of layers. For example, the source cells cannot configure monitoring subframes as MBSFN subframes by themselves.

For example, the specified node or the OAM manner specifies that: a monitoring subframe of a source cell of a first layer is subframe N (referring to one of subframes 0˜9, such as subframe 0) and a period is M (such as 10 s), a monitoring subframe of a source cell of a second layer is subframe K (referring to one of subframes 0˜9 and different from subframe N, such as subframe 1) and a period is P (which may be the same as M), a monitoring subframe of a source cell of a third layer is subframe H (referring to one of subframes 0˜9 and different from subframes N and K, such as subframe 2) and a period is Q (which may be the same as M and P), and so on. When the number of layers exceeds 10, the corresponding subframe of each layer is further defined in a manner of combining a radio frame number and a subframe. For example, the monitoring subframe of the source cell of the first layer has: a radio frame number 0 and a subframe number 0; the monitoring subframe of the source cell of the second layer has: a radio frame number 1 and a subframe number 1; and so on, and the monitoring subframes of the source cells of each layer are described by virtue of both the radio frame number and the subframe number.

The network side configures monitoring subframe positions for the source cells of each layer through the specified node or in the OAM manner, and sends information of the subframe positions to the related macro cells and small cells. In an embodiment, if the small cells are not allowed to monitor the other (adjacent) macro cells and their small cells to implement synchronization, the related small cells belong to the same macro cells, otherwise the small cells include the small cells of the adjacent macro cells or the adjacent macro cells.

The network side specifies the specified node, preferably a macro cell. Then the macro cell is required to notify affiliated small cells as well as the adjacent macro cells of configured number of layers and corresponding monitoring subframe positions so as to notify the small cells or the adjacent macro cells of the monitoring subframe positions of each layer, so that each small cell and macro cell may learn about all the monitoring subframe positions of each layer. Notification is specifically implemented as follows.

Manner 1: broadcast system messages of macro cells are used.

When such a manner is adopted, the small cells are required to acquire the broadcast system messages of the macro cells during initial configuration or initial access to the macro cells.

Manner 2: the monitoring subframe positions corresponding to each layer are placed into the corresponding macro cells or small cells during network deployment, and if updating is required, later reconfiguration is performed in the OAM manner.

Manner 3: transmission is performed through an X2 interface.

After the small cells receive the number of layers and the monitoring subframe positions of each layer, each small cell tries to synchronize with the macro cells or the other source cells, and receives reference signals sent by candidate source cells at the determined monitoring subframe positions of each layer. If the small cell selects a suitable target cell as a source cell, the small cell is also required to further determine its own corresponding number of layers.

Manner 4: a multicast manner is adopted for notification.

The specified node notifies the related small cells in the multicast manner. For example, small cells participating in monitoring join a multicast group and the specified node sends the information of the monitoring subframe positions and the number of layers in the multicast group.

The above Manners 1˜4 are also suitable for transmitting candidate source cell (or source cell set) information only by equivalently replacing the number of layers and the information of the monitoring subframe positions of each layer.

The cells try to perform air interface synchronization in monitoring subframes configured for each layer to finally determine their own suitable monitoring subframe positions, further learn about the number of layers of the source cells and their own number of layer according to the information of the monitoring subframe positions, keep the monitoring subframes corresponding to their own number of layers not configured to be MBSFN subframes and keep reference signals configured for air interface synchronization sent in the subframes. For example, small cell1 tries for air interface synchronization according to the monitoring subframe position corresponding to the first layer, and continues trying for air interface synchronization according to the monitoring subframe position corresponding to the second layer in case of poor performance until a suitable layer and a corresponding source cell are selected. If a requirement is met when small cell1 tries in the first layer, small cell1 determines that a corresponding layer number is the second layer according to the layer number if small cell1 becomes a source cell, thereby configuring itself according to the monitoring subframe position configured for the second layer and keeping a corresponding reference signal sent in the monitoring subframe. In such a manner, for the macro cells and their affiliated small cells, the underlying cells of the same layer adopt the same monitoring subframe positions, and then cells executing monitoring execute monitoring in the same subframes, so that the number of muting subframes is greatly reduced, and resources are saved. The same monitoring subframe positions are configured for the cells of the same layer, but monitored reference signals configured for the cells of the same layer are orthogonal, and RE muting may also be mutually executed.

A macro cell and affiliated small cells not required to execute monitoring in a certain monitoring subframe are required to execute muting in the subframe or execute muting in REs corresponding to monitored reference signals in the subframe.

Muting processing mentioned in the present disclosure includes both subframe muting and RE muting. Subframe muting refers to that cell 2 stops sending data in subframe 1 when cell 1 receives a reference signal from a source cell in subframe 1. RE muting refers to that cell 2 does not send data in an RE corresponding to the reference signal of the source cell in subframe 1 when cell 1 receives the reference signal from the source cell in subframe 1.

Herein, the same monitoring subframe positions are configured for the source cells of each layer for air interface synchronization, so that muting is easier to implement, resource saving is also facilitated, the number of subframes with muting requirement is reduced, and processing complexity is lowered.

In an embodiment of the present disclosure, the manner of reporting the number of layers different from the method for reporting a cell physical ID of a source cell is further provided, which may enable a macro cell to learn about cells of the same layer. Specifically, when a small cell selects a suitable source cell for air interface synchronization, the small cell should report its own layer number (i.e. the corresponding layer number when the small cell serves as a source cell), or report a layer number of its own source cell to the specified node, or to the macro cell (no matter whether the OAM manner or the specified node is adopted), and then the macro cell may preferably take the cells of the same layer into consideration when selecting a suitable Coordinated Multi-Point (CoMP) transmission cell for UE by virtue of these information because the small cells of the same layer have little timing deviations (which are almost 0). In addition, the information reported by the small cell may further include: the information of the source cell, such as information of a frequency point, cell physical ID or the like of the source cell.

There is another condition. When the small cell selects the suitable source cell, if there are multiple cells meeting a requirement on the source cell at the same time, the small cell may report information of the multiple cells to the specified node or the macro cell. The specified node or the macro cell selects a source cell for the small cell according to air interface synchronization monitoring conditions of the other small cells in a system, and notifies the small cell. Such a condition facilitates planning source cells in the system. For example, after introduction of a small cell on/off technology, the macro cell may select a cell with a heavy load and a smaller possibility of being off as the source cell of the small cell.

In addition, in consideration of impossibility of synchronization between adjacent macro cells in an FDD system, if affiliated small cell1 of macro cell1 monitors adjacent macro cell2 or a reference signal of an affiliated small cell of macro cell2 is configured for air interface synchronization, small cell1 apparently may think that it has been kept synchronized with macro cell1. In fact, small cell1 has yet not been kept synchronized with macro cell1.

In order to solve the abovementioned problem, the present disclosure further includes that the network side configures cell information of the monitored macro cells and small cells for the affiliated small cells of the macro cells through the specified node or in the OAM manner. For example, the affiliated small cells of the macro cells are configured in a set manner. In an embodiment, monitored cells configured for small cell1 include the macro cell to which small cell1 belongs and the other affiliated small cells of the macro cell. The cell information of the monitored macro cells and small cells may be sent to the small cells in the same sending or processing manner as that for the number of layers and the information of the monitoring subframe positions configured for each layer.

After the small cells receive or learn about their own optional monitored cell information (of the macro cells or the small cells), the small cells may select only the optional monitored cells, and may not select the other cells for air interface synchronization. Therefore, selectable ranges of cells for the small cells during monitoring execution may favourably be reduced.

The monitored cell information is preferably described by means of frequency points and cell physical IDs of the cells. For example: multiple groups of cell frequency points and cell physical IDs are provided. In order to reduce time for the monitoring processes of the small cells and simplify the monitoring execution processes of the small cells, bandwidth information may further be added into each group of monitored cell information, so that the small cells are not required to receive Physical Broadcast Channels (PBCHs) of the monitored source cells during execution of monitoring, the monitoring execution processes of the small cells are simplified, and monitoring time of the small cells is reduced.

Therefore, after the monitored cell information is configured, the small cells may not detect adjacent macro cells and affiliated small cells of the adjacent macro cells in the monitoring process. The monitoring cells are prevented from selecting wrong cell objects for monitoring, and the small cells are prevented from air interface synchronization errors which may not be corrected by themselves.

In an embodiment, when the specified node or the OAM manner is adopted to configure the monitored cell information for the small cells, it is learned in advance about that the adjacent macro cells are synchronized through the specified node or in the OAM manner, and then the adjacent synchronized macro cells and their affiliated small cells may be configured for be cells, which may be monitored for air interface synchronization, of the affiliated small cells of these macro cells through the specified node or in the OAM manner.

After the small cells receive the monitored cell information configured through the specified node or in the OAM manner, the small cells retrieve cell physical IDs corresponding to the cells at their own frequency points, and directly receive the reference signals of the monitoring subframe positions for air interface synchronization according to specified bandwidths without receiving the PBCHs after correctly retrieving the cell physical IDs.

The present disclosure will be described below in combination with some specific embodiments in detail.

### Embodiment 1

It is supposed that a macro cell is a specified node which configures monitoring subframe positions.

The macro cell configures the monitoring subframe positions for affiliated small cells and itself, and the monitoring subframe positions of each layer are different. That is, UE may learn about the number of layers corresponding to a monitoring subframe pattern as long as learning about the pattern. Similarly, after learning about the number of layers of a certain small cell, the UE may learn about a monitoring subframe pattern configured in the small cell. Configured information may be notified the small cells of, and a notification method specifically includes: system broadcast information notification, or X2 notification. Of course, an OAM manner may also be adopted for notification. That is, the information is configured for the small cell during deployment of the small cell. Herein, the monitoring subframe position of each layer is directly distinguished from each other based on subframes, or is distinguished from each other based on both radio frames and subframes.

It is supposed that there are 4 layers at most in the embodiment, recorded as first, second, third and fourth layers (or recorded as layers 0, 1, 2 and 3) respectively. The macro cell is configured in the first layer, and for example, it is configured that a subframe is #0 and a period is 10 s. As a node of the first layer, the macro cell keeps a reference signal (such as a CRS) configured for air interface synchronization sent in the corresponding subframe according to the monitoring subframe position configured to the first layer, that is, the macro cell may not configures its own monitoring subframe as an MBSFN subframe. The second layer is configured with a monitoring subframe position #1 and a period 10 s. The third layer is configured with a monitoring subframe position #2 and a period 10 s. The fourth layer is configured with a monitoring subframe position #3 and a period 10 s.

Multiple affiliated small cells of the macro cell may try to receive the reference signals configured for air interface synchronization from the monitoring subframe position corresponding to the first layer with the macro cell, and try to be synchronized with a source cell of the first layer. In case of successful synchronization, the small cells determine the macro cell as own source cells, further determine that they are synchronization sources of the second layer (because the small cells are synchronized with the source cell of the first layer, they are source cells of the second layer), send reference signals configured for air interface synchronization according to monitoring subframe positions configured to the second layer, and do not configure corresponding subframes as MBSFN subframes. In case of failed synchronization, the small cells continue trying to receive reference signals configured for air interface synchronization according to the monitoring subframe positions configured for the second layer, and try to synchronize with source cells of the second layer. In case of successful synchronization, the small cells determine the source cells of the second layer as their own source cells and they are source cells of the third layer, and send reference signals configured for air interface synchronization at monitoring subframe positions configured for the third layer, and so on. No elaborations will be made herein.

In an embodiment, the small cells are required to keep muting (no sending) at the monitoring subframe positions of the other small cells, or keep muting at RE positions where the synchronization reference signals are sent in the monitoring subframes of the other small cells. Here, the monitoring subframe positions of the other small cells include all the monitoring subframe positions of the first, second, third and fourth layers (there is no data sent actually in their own monitoring subframes of the small cells, except subframe positions on which the small cells are executing monitoring, equivalent to muting). For example, small cell1 monitors a small cell of the second layer for synchronization, then small cell1 is required to receive data at the monitoring subframe positions of the small cells of the second layer (equivalent to muting), is also required to keep muting at the monitoring subframe positions of the small cells of the other layers (such as the third and fourth layers), and may optionally keep muting at the monitoring subframe positions (the monitoring subframe positions in the macro cell) of the first layer. For the macro cell, small cell1 may further keep muting in an RE where a synchronization reference signal is sent in the monitoring subframe position or subframe.

When information of the monitoring subframe positions changes, the macro cell is required to send updated monitoring subframe positions of each layer to the affiliated small cells, or reconfigure the updated monitoring subframe positions for the affiliated small cells in the OAM manner.

### Embodiment 2

A macro cell configures monitored cell information for its affiliated small cells, and sends the configured monitored cell information to the affiliated small cells. The monitored cell information of each small cell may also be configured for each small cell in an OAM manner; and then the small cells execute monitoring-based air interface synchronization according to their own monitored cell information. In such a manner, ranges of source cells detected during monitoring execution of the small cells are reduced, blind detection, reception or the like during detection are reduced, execution of monitoring is accelerated, and the small cells are prevented from mistakenly monitoring reference signals of adjacent macro cells or affiliated small cells of the adjacent macro cells during air interface synchronization.

Here, each piece of monitored cell information consists of a cell frequency point, a cell physical ID and bandwidth information. If small cells deployed in the future belong to the same frequency layer, cell frequency point information may be shared information, and it is only required to be sent once.

### Embodiment 3

When a local cell is deployed, those skilled in the art may determine information of adjacent cells according to a geographical position where the local cell is deployed. If the adjacent cells and the local cell belong to the same macro cell, these cells and the macro cell are directly configured as candidate source cell information of the local cell in an OAM manner. Usually, small cells belonging to the same macro cell are all considered to be synchronized and synchronization sources are the local macro cell and the small cells belonging to the macro cell. If the adjacent cells include cells not belonging to the same macro cell with the local cell, it is necessary to further judge whether the cells belonging to other macro cells in the adjacent cells are synchronized with the macro cell to which the local cell belongs or not, and if YES, the adjacent cells may be configured to be candidate source cells of the local cell; otherwise only the cells belonging to the same macro cell with the local cell in the adjacent cells and the macro cell are configured to be the candidate source cells of the local cell.

### Embodiment 4

The embodiment is based on embodiment 3, only the operation that the candidate source cells of the local cell are configured in the OAM manner is modified into that the candidate source cell information is sent through a specified node. A specific sending manner may be an air interface manner, a system message broadcast manner, a manner of an X2 interface of a backhaul and a manner of sending the information to the local cell through a core network and then through an S1 interface by the specified node. There is no change for how to select a source cell.

### Embodiment 5

If a local cell is located outside coverage of a macro cell and may not receive an air interface signal from the macro cell, adjacent cells (small cells) or small cells in the same cluster are selected as candidate source cells of the local cell. For the adjacent cells, if the adjacent cells include cells not belonging to the same cluster with the local cell, it is necessary to further judge whether the cells are synchronized with the small cells in the cluster or not, and if YES, the cells may be determined as the candidate source cells of the local cell, otherwise they may not be determined as the candidate source cells of the local cell.

The embodiments of the present disclosure further provide a configuration node for implementing air interface synchronization. As shown in FIG. 2, the node 20 includes: a configuration module 201 and a transmission module 202.

The configuration module 201 is configured to determine the number of layers to which cells are divided and configure monitoring subframe positions for air interface synchronization for the cells of each determined layer, or, is configured to determine a source cell which may be monitored by a local cell for air interface synchronization, configure cell information corresponding to the source cell and configure the cell information to be the local cell.

The transmission module 202 is configured to send or configure the number of layers and information of the monitoring subframe positions configured to the cells of each layer, or, is configured to send the cell information to be the local cell.

In an embodiment, when the local cell is a small cell, the configuration module is further configured to, when it is determined that an adjacent macro cell is kept synchronized with the node, determine the adjacent macro cell and its small cell as candidate source cells or source cells which are monitored by the local cell for air interface synchronization.

In an embodiment, the configuration module 201 is further configured to select one or more cells from received information of potential source cells as (a) candidate source cell(s) or source cell(s) of the local cell, or, is configured to select a cell from candidate source cells as a source cell of the local cell.

In an embodiment, the configuration module 201 is further configured to set monitoring radio frame and/or subframe positions for air interface synchronization of source cells of the same layer to be the same.

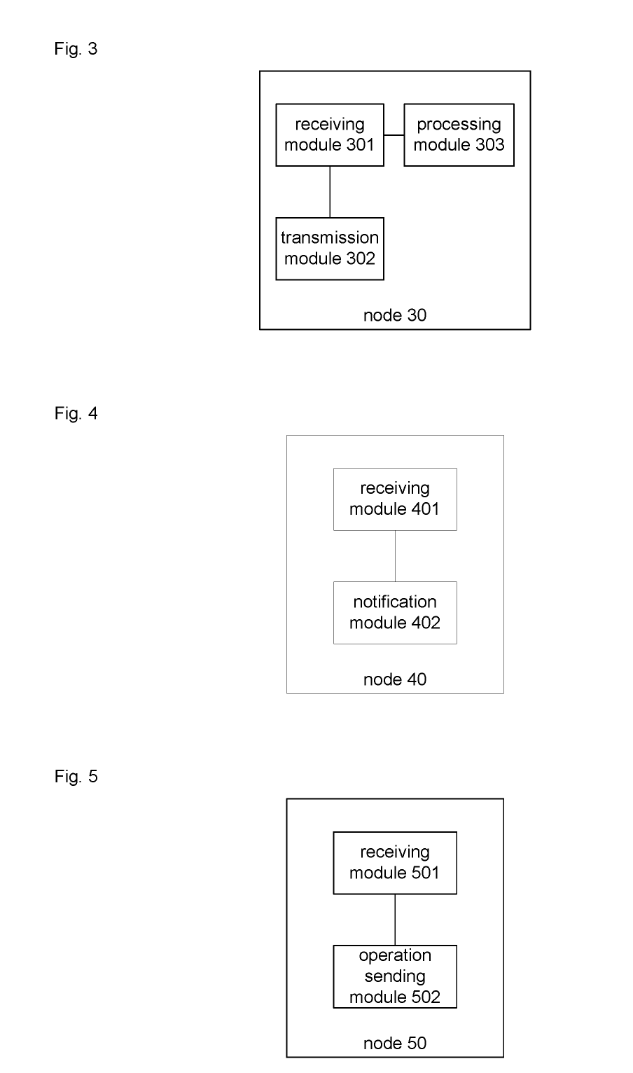

The embodiments of the present disclosure further provide a configuration node for implementing air interface synchronization. As shown in FIG. 3, the node 30 includes: a receiving module 301, configured to receive the number of layers to which cells are divided, configured in an OAM manner and information of monitoring subframe positions configured to the cells of each layer for air interface synchronization, or,

configured to receive the number of layers to which cells are divided and information of monitoring subframe positions configured to the cells of each layer for air interface synchronization, or,

configured to receive cell information corresponding to a source cell which is monitored for air interface synchronization, or,

configured to receive cell information corresponding to a source cell which is monitored for air interface synchronization in the OAM manner.

In an embodiment, after receiving the number of layers to which the cells are divided and the information of the monitoring subframe positions configured to the cells of each layer for air interface synchronization, the receiving module 301 is further configured to determine the layer number of the node and determine a configured monitoring subframe position of the node according to the determined layer number.

In an embodiment, when the node is a source cell, the receiving module 301 is further configured to determine the configured monitoring subframe position of the node according to the determined layer number.

In an embodiment, the node further includes: a transmission module 302, configured to send a monitored signal in a configured monitoring subframe, which is determined by the receiving module, of the node.

In an embodiment, the node further includes a processing module 303, configured to keep subframe muting in other monitoring subframes except the monitoring subframe of the node, or,

keep muting of REs corresponding to monitored signals in the other monitoring subframes except the monitoring subframe of the node.

In an embodiment, the processing module 303 is further configured to execute monitoring operation according to the monitoring subframe positions configured to each layer respectively and try to select a source cell suitable for the node.

In an embodiment, after the receiving module 301 receives the cell information corresponding to the source cell which is monitored for air interface synchronization, the processing module 303 is further configured to detect the source cell of the node by virtue of the cell information.

In an embodiment, the processing module 303 is further configured to report selected source cell information, the source cell information including: a cell physical ID.

In an embodiment, the processing module 303 is further configured to report information of a detected candidate source cell.

The embodiments of the present disclosure further provide a configuration system for implementing air interface synchronization including the abovementioned two nodes.

The embodiments of the present disclosure further provide a configuration node for implementing air interface synchronization. As shown in FIG. 4, the node 40 includes: a receiving module 401 and a notification module 402.

The receiving module 401 is configured to receive air interface synchronization reference signals from multiple cells and determine a source cell or candidate source cell suitable for a local cell.

The notification module 402 is configured to notify the source cell or a specified node of source cell information or candidate source cell information determined by the receiving module 401.

In an embodiment, the operation that the notification module 402 notifies the source cell or the specified node of the source cell information or the candidate source cell information includes that:

the notification module 402 notifies the source cell or the specified node through a dedicated RRC message; or,

the notification module 402 notifies the source cell or the specified node through an X2 interface; or,

the notification module 402 notifies a core network through an S1 interface, and then the core network notifies the source cell or the specified node through an S1 interface.

The embodiments of the present disclosure further provide a configuration node for implementing air interface synchronization. As shown in FIG. 5, the node 50 includes: a receiving module 501, configured o receive source cell information or candidate source cell information notified by a local cell.

The source cell information or the candidate source cell information is a source cell or candidate source cell, determined by air interface synchronization reference signals received from multiple cells by the local cell, suitable for the local cell.

In an embodiment, the node further includes an operation sending module 502. After the receiving module 501 receives the source cell information or candidate source cell information notified by the local cell,

the operation sending module 502 is configured to learn about that the source cell serves as a source cell or candidate source cell of other cells except itself, awaken the source cell at a subframe position where an air interface synchronization reference signal of the source cell is received by the local cell after switching off and send the air interface synchronization reference signal at the subframe position.

As can be seen, in the embodiment of the present disclosure, a unified node is adopted to configure the monitoring subframe positions and the number of layers, which is favourable for implementation of a subframe muting or RE muting solution, greatly reduces resources required by muting and may avoid signalling interaction. Otherwise, small cells are required to interact about monitoring subframe position information, thereby causing muting of the other small cells at monitoring subframe positions of each small cell.

In addition, in the embodiment of the present disclosure, after cell information which may be configured for a source cell is notified a small cell, a monitoring step and calculation of the small cell are favourably simplified, and the problem of misunderstanding of the small cell about synchronization with a macro cell is solved.

Those skilled in the art should understand that the embodiments of the present disclosure may be provided as a method, a system or a computer program product. Therefore, the present disclosure may adopt a form of pure hardware, pure software and combination thereof. Moreover, the present disclosure may adopt a form of computer program product implemented on one or more computer-available storage media (including, but not limited to, a disk memory, an optical memory or the like) including computer-available program codes.

The present disclosure is described with reference to flowcharts and/or block diagrams of the method, equipment (system) and computer program product according to the embodiment of the present disclosure. It should be understood that each flow and/or block in the flowcharts and/or the block diagrams and combinations of the flows and/or blocks in the flowcharts and/or the block diagrams may be implemented by computer program instructions. These computer program instructions may be provided for a universal computer, a dedicated computer, an embedded processor or a processor of other programmable data processing equipment to generate a machine, so that a device for realizing a function specified in one flow or more flows in the flowcharts and/or one block or more blocks in the block diagrams is generated by the instructions executed through the computer or the processor of the other programmable data processing equipment.

These computer program instructions may also be stored in a computer-readable memory capable of guiding the computer or the other programmable data processing equipment to work in a specific manner, so that a product including an instruction device may be generated by the instructions stored in the computer-readable memory, the instruction device realizing the function specified in one flow or many flows in the flowcharts and/or one block or many blocks in the block diagrams.

These computer program instructions may further be loaded onto the computer or the other programmable data processing equipment, so that a series of operating steps are executed on the computer or the other programmable data processing equipment to generate processing implemented by the computer, and steps for realizing the function specified in one flow or many flows in the flowcharts and/or one block or many blocks in the block diagrams are provided by the instructions executed on the computer or the other programmable data processing equipment.

The above is only the preferred embodiments of the present disclosure and not intended to limit the scope of protection of the present disclosure.

1. A configuration method for implementing air interface synchronization, comprising:
determining, by a network side, the number of layers to which cells are divided in an Operation, Administration and Maintenance (OAM) manner or by a specified node, configuring monitoring subframe positions for air interface synchronization for the cells of each determined layer, and sending or configuring the number of layers and information of the monitoring subframe positions for the cells of each layer; or,
determining in an Operation, Administration and Maintenance (OAM) manner, by a network side, a source cell configurable to be monitored for air interface synchronization by a local cell, configuring cell information corresponding to the source cell and configuring the cell information to be the local cell; or,
determining, by a specified node, a source cell configurable to be monitored for air interface synchronization by a local cell, configuring cell information corresponding to the source cell and sending the cell information as the local cell.

2. The method according to claim 1, wherein the specified node is a macro cell or a specified small cell, and
wherein when the local cell is a small cell, the configured source cell comprises: a small cell belonging to the same macro cell with the local cell and the macro cell.

3. The method according to claim 1, wherein sending the cell information as the local cell comprises:
sending, by the specified node, the cell information as the local cell through an X2 interface of a backhaul link, or sending, by the specified node, the cell information to a core network, and sending, by the core network, the cell information to the local cell.

4. The method according to claim 1, wherein the cell information corresponding to the source cell configurable to be monitored for air interface synchronization comprises: frequency point information and cell physical Identifier (ID) of the cell, or,
frequency point information, cell physical ID and bandwidth information of the cell, or,
information of a cell cluster where the source cell is located, or,
frequency point information, cell physical ID and timing deviation information of the cell.

5. (canceled)

6. The method according to claim 2, when the local cell is a small cell, further comprising: when the specified node determines that an adjacent macro cell is kept synchronized with itself, determining the adjacent macro cell and its small cells as candidate source cells or source cells which are monitored by the local cell for air interface synchronization.

7. The method according to claim 1, further comprising:
selecting, by the specified node, one or more cells from received information of potential source cells as (a) candidate source cell(s) or source cell(s) of the local cell; or, specifying, by the specified node, a cell as a source cell of the local cell; or, selecting, by the local cell, a cell from candidate source cells as a source cell of the local cell.

8. The method according to claim 1, further comprising:
setting, by the specified node, monitoring radio frame and/or subframe positions for air interface synchronization, of source cells of the same layer to be the same.

9. A configuration method for implementing air interface synchronization, comprising:
receiving, by a related cell, the number of layers to which cells are divided, configured in an Operation, Administration and Maintenance (OAM) manner and information of monitoring subframe positions for air interface synchronization configured for the cells of each layer; or,
receiving, by a related cell, the number of layers to which cells are divided and information of monitoring subframe positions for air interface synchronization configured for the cells of each layer; or,
receiving, by a related cell, cell information corresponding to a source cell which is monitored for air interface synchronization; or,
receiving, by a related cell, cell information corresponding to a source cell which is monitored for air interface synchronization in the OAM manner.

10. The method according to claim 9, wherein the related cell comprises: a small cell belonging to the same macro cell and the macro cell.

11. The method according to claim 9, wherein receiving, by the related cell, the cell information corresponding to the source cell which is monitored for air interface synchronization comprises:
receiving, by the related cell, the cell information through an X2 interface of a backhaul link, or receiving, by the related cell, the cell information sent by a core network through an S1 interface.

12. The method according to claim 9, after receiving, by the related cell, the number of layers to which the cells are divided and the information of the monitoring subframe positions for air interface synchronization configured for the cells of each layer, the method further comprising:
determining, by the related cell, its own layer number, and determining its own configured monitoring subframe position according to the determined layer number.

13. The method according to claim 12, wherein determining, by the related cell, its own layer number comprises:
determining its own source cell by detection, and acquiring a layer number of the source cell, thereby determining its own layer number by adding 1 to the layer number of the source cell.

14. The method according to claim 12, when the related cell is a source cell, the method further comprising:
determining, by the related cell, its own configured monitoring subframe position according to its own determined layer number,
wherein the method further comprises: sending, by the related cell, a monitoring signal in its own configured monitoring subframe.

15. (canceled)

16. The method according to claims 9, further comprising:
keeping, by the related cell, other monitoring subframes except its own monitoring subframe muting; or, keeping, by the related cell, REs corresponding to monitoring signals in the other monitoring subframes except its own monitoring subframe muting.

17. The method according to claims 9, further comprising:
executing, by the related cell, monitoring operation according to the monitoring subframe position configured for each layer respectively and trying to select a suitable source cell.

18. The method according to claims 9, after receiving, by the related cell, the cell information corresponding to the source cell which is monitored for air interface synchronization, the method further comprising:
detecting, by the related cell, its own source cell by virtue of the cell information.

19. The method according to claim 18, further comprising:
reporting, by the related cell, selected source cell information, wherein the source cell information comprises a cell physical Identifier (ID).

20. The method according to claim 18, further comprising:
reporting, by the related cell, information of a detected candidate source cell.

21-34. (canceled)

35. A configuration method for implementing air interface synchronization, comprising:
receiving, by a local cell, air interface synchronization reference signals from a plurality of cells, determining a source cell or candidate source cell suitable for the local cell and notifying the source cell or a specified node of determined source cell information or candidate source cell information.

36. The method according to claim 35, wherein a method for notifying the source cell or the specified node of the determined source cell information or candidate source cell information comprises:
notifying, by the local cell, the source cell or the specified node through a dedicated Radio Resource Control (RRC) message; or,
notifying, by the local cell, the source cell or the specified node through an X2 interface; or,
notifying, by the local cell, a core network through an S1 interface, and notifying, by the core network, the source cell or the specified node through an S1 interface.

37-42. (canceled)
